(19) United States
(12) Patent Application Publication
(10) Pub. No.: US 2025/0020096 A1
(43) Pub. Date: Jan. 16, 2025

(54) Electromagnetic Fuel Injector With Two Independent Coils and Related Control Method

(71) Applicant: MARELLI EUROPE S.P.A., Corbetta (IT)

(72) Inventors: Giorgio Signorelli, Corbetta (IT); Michele Petrone, Corbetta (IT); Stefano Petrecchia, Corbetta (IT); Massimo Mattioli, Corbetta (IT); Martina La Malfa, Corbetta (IT); Francesco Zampolli, Corbetta (IT); Nicola Mundo, Corbetta (IT); Luca Mancini, Corbetta (IT)

(73) Assignee: MARELLI EUROPE S.P.A., Corbetta (IT)

(21) Appl. No.: 18/767,031

(22) Filed: Jul. 9, 2024

(30) Foreign Application Priority Data
Jul. 10, 2023 (IT) 102023000014394

(51) Int. Cl. F02M 51/06; F02M 61/20; F02M 63/00

(52) U.S. Cl. CPC F02M 51/0625; F02M 61/20; F02M 63/0056

(57) ABSTRACT

An electromagnetic fuel injector having: a tubular support body; an injection nozzle arranged at an end of the support body; an injection valve coupled to the injection nozzle; a plunger, which is movable, so as to adjust the fuel flow through the injection nozzle, between a closed position and an open position of the injection valve; an electromagnetic actuator provided with a main electromagnet configured, when it is activated, to apply a force to the plunger, which pushes the plunger towards the open position of the injection valve and with a secondary electromagnet configured, when it is activated, to apply a force to the plunger, which pushes the plunger towards the closed position of the injection valve; and a closing spring configured to push the plunger towards the closed position of the injection valve.

### CROSS-REFERENCE TO RELATED APPLICATIONS

This patent application claims priority from Italian patent application no. 102023000014394 filed on Jul. 10, 2023, the entire disclosure of which is incorporated herein by reference.

### TECHNICAL FIELD

The present invention relates to an electromagnetic fuel injector and to a related control method.

The present invention is advantageously applied to an electromagnetic hydrogen injector, to which the following discussion will explicitly refer without thereby losing generality.

### PRIOR ART

Generally, an electromagnetic fuel injector (for example as described in patent application EP1611384A2) comprises a cylindrical tubular support body equipped with a central supply channel, which acts as fuel duct and ends with an injection nozzle adjusted by an injection valve controlled by an electromagnetic actuator. The injection valve is provided with a plunger, which is moved by the action of the electromagnetic actuator between a closed position and an open position of the injection nozzle against the action of a closing spring which pushes the plunger towards the closed position. The plunger ends with a shutter head adapted to sealingly rest against a valve seat of the injection valve.

The electromagnetic actuator comprises a (at least one) coil arranged externally and in a fixed position around the support body, a movable armature made of ferromagnetic material which is rigidly connected to the plunger and is mounted movable inside the support body, and a fixed armature (or bottom) made of ferromagnetic material which is arranged inside the support body in the area of the coil and is adapted to magnetically attract the armature when the coil is excited.

When a liquid fuel is injected, the presence of the liquid fuel inside the support body constitutes a relevant obstacle for the movement of the movable armature creating in actual fact a hydraulic damper which limits the movement speed of the movable armature; whereas, when a gaseous fuel is injected (and particularly when hydrogen, which is an extremely light gas, is injected) the presence of the gaseous fuel inside the support body does not constitute a relevant obstacle for the movement of the movable armature and thus the movable armature moves at high speeds and violently impacts against the armature at the end of the opening movement. This violent impact of the movable armature against the armature at the end of the opening movement causes both a high noise level and an accelerated degradation (wear); furthermore, the violent impact of the movable armature against the armature at the end of the opening movement also causes a relevant bounce phenomenon which introduces a certain dose of randomness in the quantity of fuel which is injected.

In such regard, it is important to observe that hydrogen has a reduced density (having a very simple molecule composed of only two hydrogen atoms) and therefore in order to be able to inject a sufficient quantity (mass) of hydrogen into a combustion chamber, it is necessary to inject a corresponding relevant volume of hydrogen and this, among other things, requires a high area of the passage zone of hydrogen through the injection valve (i.e. the opening through which hydrogen must pass so as to exit the hydrogen injector must be large). In order to have a high area of the passage zone of hydrogen through the injection valve, it is necessary for the plunger (thus the movable armature) to have a long movement between the closed position and the open position and this further increases an impact speed of the movable armature against the armature at the end of the opening movement.

In order to limit the impact speed of the movable armature against the armature at the end of the opening movement, particular profiles of the current which passes through the coil of the electromagnetic actuator are currently utilized and which should enable reducing, when the movable armature is close to the armature, the magnetic force attracting the movable armature towards the armature; however, the control of the magnetic force attracting the movable armature towards the armature when the movable armature is close to the armature is extremely complex and relatively not very precise since in this position the magnetic force attracting the movable armature towards the armature is strongly non-linear (namely increases in an exponential manner when the air gap between the movable armature and the armature becomes very small).

Patent application DE10101060A1 describes a fuel injector for a diesel engine comprising: a throttling needle for locking the passage of the injection, an armature mounted on the needle, an electric opening solenoid for applying on the armature an induced magnetic field which moves the armature towards an open position of the injection passage, and an electric closing solenoid which applies on the armature an induced magnetic field which moves the armature towards a closed position of the injection passage.

### DESCRIPTION OF THE INVENTION

The object of the present invention is to manufacture an electromagnetic fuel injector which is devoid of the drawbacks described above, namely has a low noise level and a modest degradation (wear), and simultaneously, is easy and cost-effective to manufacture.

According to the present invention, an electromagnetic fuel injector and a related control method are provided, as claimed in the appended claims.

The claims illustrate a preferred embodiment of the present invention being integral part of this description.

### BRIEF DESCRIPTION OF THE DRAWINGS

The present invention will now be described with reference to the accompanying drawings, which illustrate a non-limiting example embodiment thereof, wherein:

FIG. 1 is a longitudinal section of part of a fuel injector manufactured in accordance with the present invention;

FIG. 2 is a view on an enlarged scale of a detail of FIG. 1; and

FIG. 3 is a graph showing the time evolution of the position of a movable assembly and of the activation of two electromagnets of the fuel injector of FIG. 1 during an opening and a subsequent closing of an injection valve.

### PREFERRED EMBODIMENTS OF THE INVENTION

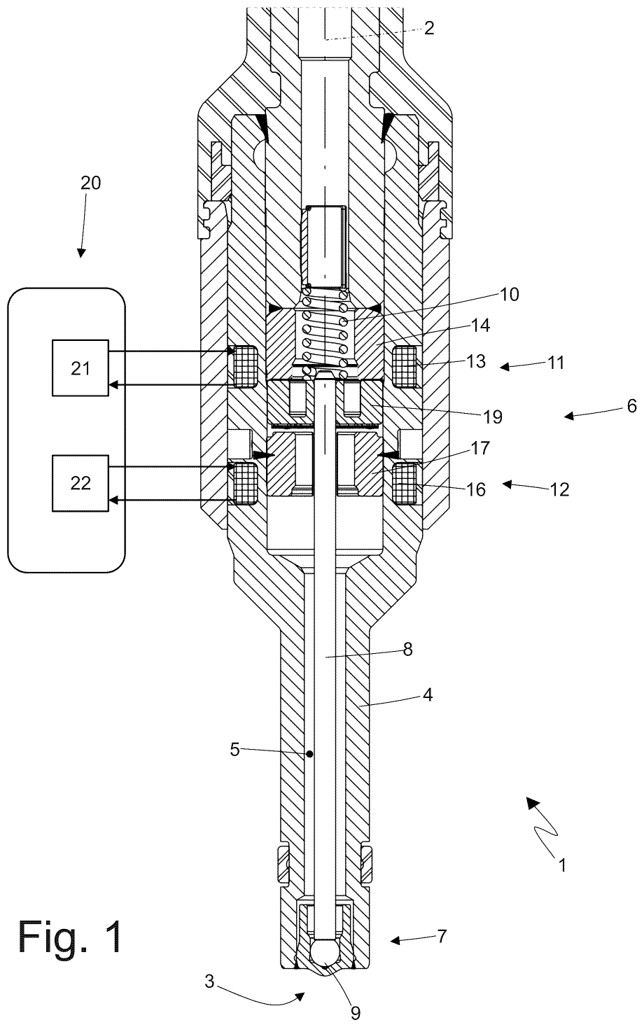

In FIG. 1, reference numeral 1 indicates, as a whole, a gaseous (in particular hydrogen) electromagnetic fuel injector, which has a cylindrical symmetry around a longitudinal axis 2 and is adapted to be controlled for injecting hydrogen through an injection nozzle 3 which directly flows into a combustion chamber of a cylinder of an internal combustion engine (not illustrated).

The electromagnetic injector 1 comprises a support body 4, which has a cylindrical tubular shape with a variable section along the longitudinal axis 2 and has a supply channel 5 which extends along the entire length of the support body 4 for supplying hydrogen under pressure towards the injection nozzle 3.

The support body 4 houses an electromagnetic actuator 6 and an injection valve 7; in use, the injection valve 7 is operated by the electromagnetic actuator 6 for adjusting the hydrogen flow through the injection nozzle 3, which is obtained in the area of the injection valve 7.

The electromagnetic actuator 6 is configured to axially move (namely along the longitudinal axis 2) a movable assembly provided with a plunger 8 which ends with a shutter 9. The shutter 9 cooperates with a valve seat of the injection valve 7 for adjusting the hydrogen flow through the injection nozzle 3. In other words, the support body 4 ends with a (at least one) through opening in which the valve seat is defined and which is engaged by the shutter 9. In particular, the electromagnetic actuator 6 is configured to move the shutter 9 between a closed position and an open position of the injection valve 7. Furthermore, the electromagnetic actuator 6 is coupled to a closing spring 10 which keeps the electromagnetic injector 1 normally closed, namely which pushes the shutter 9 towards the closed position of the injection valve 7. In other words, normally the injection valve 7 is closed by effect of the closing spring 10 which pushes the plunger 8 into the closed position, in which the shutter 9 of the plunger 8 presses against the valve seat of the injection valve 7.

In the embodiment illustrated in the accompanying figures, the injection valve 7 opens with an axial movement towards the inside and preferably the shutter 9 has a spherical shape; according to a different embodiment not illustrated, the injection valve 7 opens with an axial movement towards the outside and preferably the shutter 9 has a truncated cone shape.

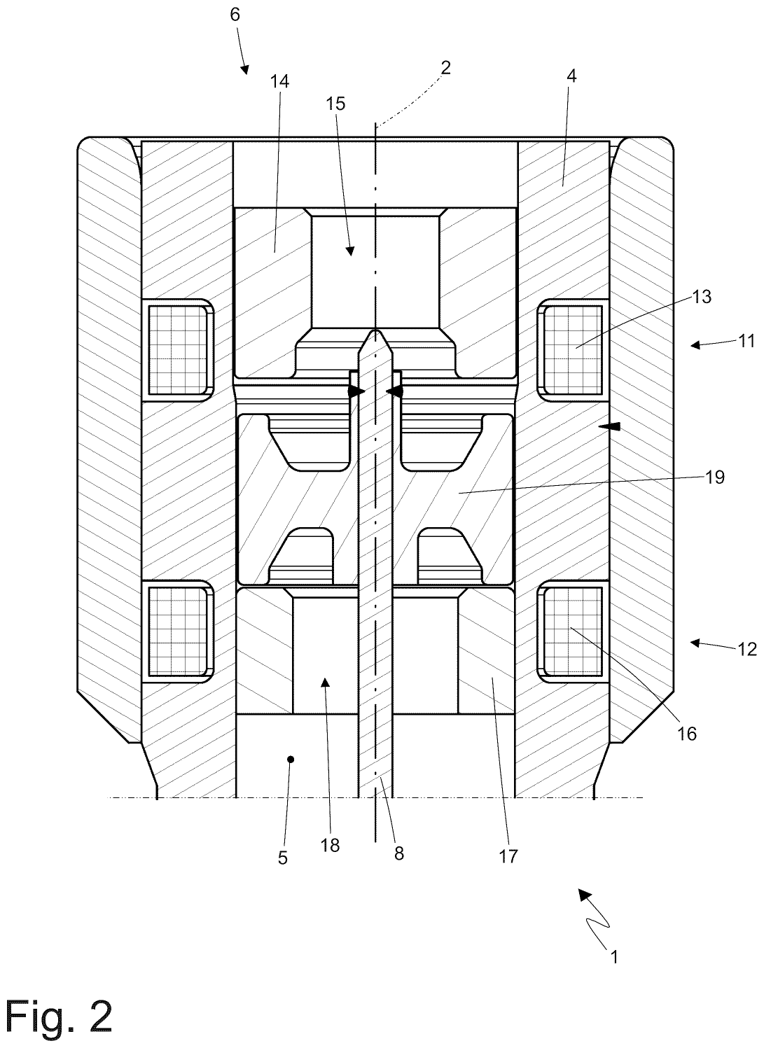

According to what is better illustrated in FIG. 2, the electromagnetic actuator 6 comprises a main electromagnet 11 and a secondary electromagnet 12 which are controlled in an independent manner: the main electromagnet 11 is configured (when it is activated) to impress a force on the plunger 8 which opens the injection valve 7 (thus opposite the elastic force generated by the closing spring 10), whereas the secondary electromagnet 12 is configured (when it is activated) to impress a force on the plunger 8 which closes the injection valve 7 (thus concordant with the elastic force generated by the closing spring 10). In other words, the two electromagnets 11 and 12 are configured to impress forces on the plunger 8 which are opposite one another.

The main electromagnet 11 comprises a main coil 13 housed externally with respect to the support body 4 and a main armature 14 (pole or bottom or magnetic expansion) made of ferromagnetic material, which is housed inside the support body 4 in a fixed position in the area of the main coil 13 and has a central hole 15 for allowing the fuel to flow towards the injection nozzle 3; namely, the armature 14 is inserted inside the support body 4 and is integral with the support body 4 (generally it is welded to the support body 4).

The secondary electromagnet 12 comprises a secondary coil 16 housed externally with respect to the support body 4 and a secondary armature 17 (pole or bottom or magnetic expansion) made of ferromagnetic material, which is housed inside the support body 4 in a fixed position in the area of the secondary coil 16 and has a central hole 17 for allowing the fuel to flow towards the injection nozzle 3; namely, the armature 17 is inserted inside the support body 4 and is integral with the support body 4 (generally it is welded to the body 4).

In the embodiment illustrated in the accompanying figures, one single armature 19 is provide which is integral with the plunger 8 (namely is part of the movable assembly), is arranged between the two armatures 14 and 17 and is shared by both electromagnets 11 and 12; namely, the armature 19 is magnetically coupled to both the main coil 13 since it is passed through by the magnetic flow generated by the main coil 13, and to the secondary coil 17 since it is passed through by the magnetic flow generated by the secondary coil 17. Namely, by exciting the main coil 13, the magnetic field which is generated attracts the armature 19 towards the main armature 14 and in a similar manner by exciting the secondary coil 16 the magnetic field which is generated attracts the armature 19 towards the secondary armature 17. According to a different embodiment not illustrated, each electromagnet 11 or 12 comprises an armature 19 of its own and thus two armatures 19 are provided which are separate from and independent of each other and both integral with the plunger 8 (namely part of the movable assembly); in this embodiment, each electromagnet 11 or 12 is configured to magnetically attract only the corresponding armature 19.

The electromagnetic injector 1 comprises (is connected to) a control unit 20 (schematically illustrated in FIG. 1) which electrically powers the two coils 13 and 16 of the two electromagnets 11 and 12 independently of each other; namely, the control unit 20 drives (electrically powers) the main coil 13 of the main electromagnet 11 independently of the secondary coil 16 of the secondary electromagnet 12. In particular, the control unit 20 comprises a controller 21 which is connected only to the main coil 13 for electrically powering only the main coil 13 and a controller 22 which is connected only to the secondary coil 16 for electrically powering only the secondary coil 16.

In other words, the electromagnets 11 and 12 are controlled independently, namely the two coils 13 and 16 are not connected to each other in series or in parallel and are powered by two different controllers 21 and 22 so as to be passed through by different and differentiated electric currents (as is better explained in the following).

In use, when the electromagnets 11 and 12 are de-energized, the armature 19 is not subjected to any force having magnetic origin and thus is only subjected to the elastic force generated by the closing spring 10 which pushes the armature 19 together with the plunger 8 towards the closed position (namely downwards) and in this situation, the injection valve 7 is closed; preferably, in the closed position, the armature 19 is close to (near) the secondary armature 17 but not in contact with the secondary armature 17, namely there is free space between the armature 19 and the secondary armature 17 (consequently the “stop” of the closed position is established by the contact of the shutter 9 against the valve seat of the injection valve 7 and not by the contact of the armature 19 against the secondary armature 17).

In use, in order to open the injection valve 7, the main electromagnet 11 is activated (namely the main coil 13 is excited) so that the main electromagnet 11 generates a magnetic force attracting the armature 19 towards the main armature 14 (namely towards the open position) overcoming the elastic force of the closing spring 10; consequently, the armature 19 moves towards the main armature 14 (namely towards the open position) determining the progressive opening of the injection valve 7. When the armature 19 is close to the main armature 14 (namely is close to the open position), also the secondary electromagnet 12 is activated (namely the secondary coil 16 is excited) so that the secondary electromagnet 12 generates a magnetic force attracting the armature 19 towards the secondary armature 17 consequently slowing down the movement of the armature 19 towards the main armature 14 (namely towards the open position). It is important to observe that the magnetic force generated by the secondary electromagnet 12 is not able (i.e. is not sufficiently strong) to stop or invert the motion of the armature 19 towards the main armature 14 (namely towards the open position) and only has the effect of slowing down (braking) the movement of the armature 19 towards the main armature 14 (namely towards the open position). Therefore, at the end of the opening step, the armature 19 ends its movement against the main armature 14 (the “stop” of the open position is established by the contact of the armature 19 against the main armature 14) against which it impacts at a relatively modest speed by effect of the slowing down (braking) action exerted by the secondary electromagnet 12 (more in general, the “stop” of the open position is established by the contact of an element of the movable assembly against a fixed element integral with the support body 4).

Once the armature 19 arrives to be in contact with the main armature 14, in order to keep the injection valve 7 open, only the main electromagnet 11 is kept active (generally by powering the main coil 13 with an electric current having a smaller intensity since, in order to keep the open position, a reduced magnetic force is sufficient), whereas the secondary electromagnet 12 is turned off (since its function is useless when the armature 19 is still and in contact with the main armature 14).

In use, in order to close the injection valve 7, the main electromagnet 11 is turned off so that the armature 19, no longer subjected to any force having magnetic origin, is pushed by the elastic force generated by the closing spring 10 towards the closed position (namely downwards) and thus the armature 19 detaches from the main armature 14 and moves towards the secondary armature 17 (which will never reach, namely will never arrive to be in contact with the secondary armature 17, since the “stop” of the closed position is established by the contact of the shutter 9 against the valve seat of the injection valve 7 before a contact of the armature 19 against the secondary armature 17 occurs). Generally, during the entire closing step, the secondary electromagnet 12 remains turned off since for a quick closing of the injection valve 7 the elastic force generated by the closing spring 10 is sufficient; according to an alternative embodiment, at least in the initial part of the closing step, the secondary electromagnet 12 could be activated (by exciting the secondary coil 16) for increasing the speed of the armature 19 towards the main armature 14 and thus quicken the closing step.

When the shutter 9 is close to the valve seat of the injection valve 7, the main electromagnet 11 is briefly activated (reactivated) (namely the main coil 13 is excited) so that the main electromagnet 11 generates a magnetic force attracting the armature 19 towards the main armature 14 consequently slowing down the movement of the armature 19 towards the closed position. It is important to observe that the magnetic force generated at the end of the closing step by the main electromagnet 11 is not able (i.e. is not sufficiently strong) to stop or invert the motion of the armature 19 towards the closed position and only has the effect of slowing down (braking) the movement of the armature 19 towards the closed position. Therefore, at the end of the closing step, the armature 19 ends its movement when the shutter 9 impacts against the valve seat of the injection valve 7 (the “stop” of the closed position is established by the contact of the shutter 9 against the valve seat of the injection valve 7) against which it impacts at a relatively modest speed by effect of the slowing down (braking) action exerted by the main electromagnet 11.

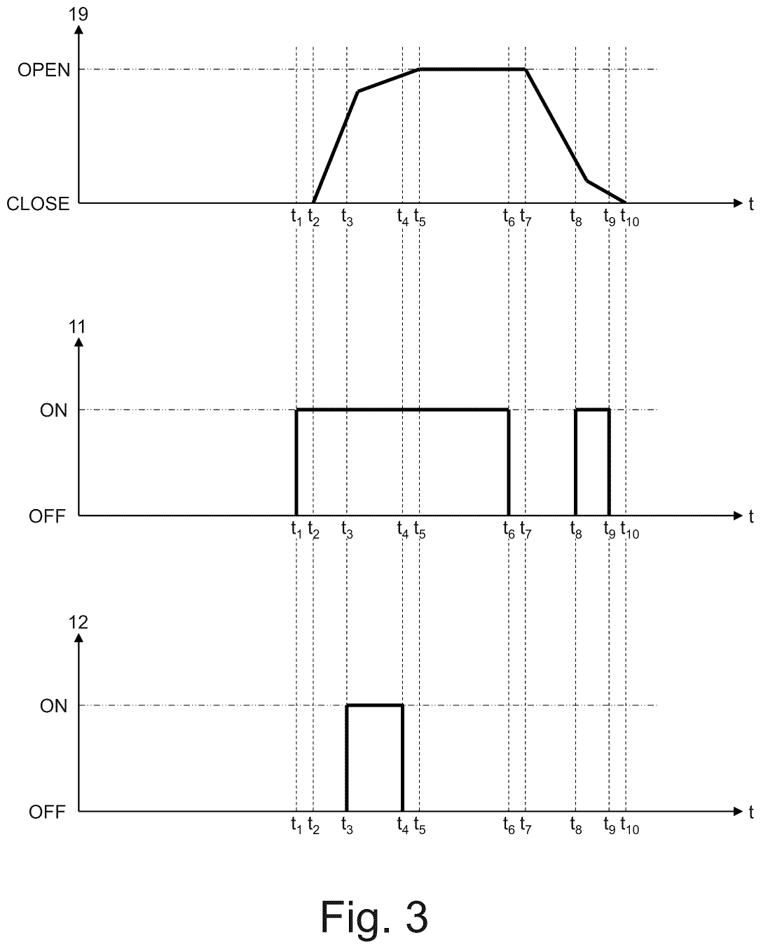

What described above is schematically illustrated in FIG. 3, which in the upper zone illustrates the time trend of the position of the movable assembly (namely of the armature 19, of the plunger 8 and of the shutter 9) which moves between the closed position (“CLOSE”) and the open position (“OPEN”), in the intermediate zone illustrates the time trend of the status of the main electromagnet 11 which varies between the deactivated condition (“OFF”) and the active condition (“ON”), and in the lower zone illustrates the time trend of the status of the secondary electromagnet 12 which varies between the deactivated condition (“OFF”) and the active condition (“ON”).

According to what is illustrated in FIG. 3, before the instant t₁ both electromagnets 11 and 12 are turned off and thus the armature 19 (namely the movable assembly) is still in the closed position. At the instant t₁ the main electromagnet 11 is activated, and (by effect of the electromagnetic and mechanical inertia) at the instant t₂ said main electromagnet 11 starts moving the armature 19 from the closed position towards the open position which is reached at the instant t₅. Between the instant ty and the instant t₄ also the secondary electromagnet 12 is activated for slowing down (braking) the armature 19 close to the open position (namely just before the armature 19 impacts against the main armature 14); the effect of the secondary electromagnet 12 is not immediate by effect of the electromagnetic and mechanical inertia and the secondary electromagnet 12 is deactivated before the armature 19 reaches the open position so as to account for the effect of the electromagnetic and mechanical inertia. At the instant to the main electromagnet 11 is deactivated and thus (by effect of the electromagnetic and mechanical inertia) at the instant ty the action of the closing spring 10 pushes the armature 19 towards the closed position which is reached at the instant to. Between the instant t₅ and the instant t₉ the main electromagnet 11 is activated for slowing down (braking) the armature 19 close to the open position (namely just before the shutter 9 impacts against the valve seat of the injection valve 7); the effect of the main electromagnet 11 is not immediate by effect of the electromagnetic and mechanical inertia and the main electromagnet 11 is deactivated before the armature 19 reaches the closed position so to account for the effect of the electromagnetic and mechanical inertia.

According to a preferred embodiment, the electromagnets 11 and 12 are open-loop controlled making predetermined electric current trends (profiles) circulate in the respective coils 13 and 16; self-calibration logics could be provided which estimate the actual opening and/or closing instants of the injection valve 7 and based on the actual opening and/or closing instants of the injection valve 7 they can provide (if necessary) correctives to the predetermined electric current trends (profiles).

According to a possible embodiment, during the entire closing step, the main electromagnet 11 remains turned off (especially if also the secondary electromagnet 12 remains turned off).

According to an alternative embodiment, when the armature 19 is close to the “stop” of the closed position (established by the contact of the shutter 9 against the valve seat of the injection valve 7), the main electromagnet 11 is activated (namely the main coil 13 is excited) so that the main electromagnet 11 generates a magnetic force attracting the armature 19 towards the main armature 14 consequently slowing down the movement of the armature 19 towards the main armature 14. It is important to observe that the magnetic force generated by the main electromagnet 11 during the closing step is not able (i.e. is not sufficiently strong) to stop or invert the motion of the armature 19 towards the secondary armature 17 and only has the effect of slowing down (braking) the movement of the armature 19 towards the secondary armature 17. Therefore, at the end of the closing step, the armature 19 ends its movement when the shutter 9 arrives to be in contact (impacts) with the valve seat of the injection valve 7 (namely the “stop” of the closed position is reached), contact (impact) which occurs at a relatively modest speed by effect of the slowing down (braking) action exerted by the main electromagnet 11.

According to a preferred embodiment, the two coils 13 and 16 are different from each other since they have to generate magnetic forces of different intensity and in different conditions: the main coil 13 (in combination with the main armature 14) has to generate a magnetic force sufficient for overcoming the elastic force of the closing spring 10 attracting the armature 19 towards the main armature 14, whereas the secondary coil 16 (in combination with the secondary armature 17) has to slow down (without stopping) the end part of the movement of the armature 19 towards the main armature 14. Therefore, the two coils 13 and 16 generally differ from each other in the number of turns and thus in shape and/or dimension.

Summarizing what described above, the movable assembly (thus the plunger 8 carrying the shutter 9) is subjected (in addition to the elastic force generated by the closing spring 10) to two magnetic forces which are independent of each other since they are generated by the two electromagnets 11 and 12 which are driven independently of each other.

In the preferred embodiment described above, the electromagnetic injector 1 is configured to inject hydrogen, but alternatively the electromagnetic injector 1 could be configured to inject any other type of gaseous fuel such as, for example, methane or could be configured to also inject a liquid fuel or water (generally when a high injection flow rate is required which requires particularly long movements of the plunger 8).

The embodiments described herein can be combined with one another without departing from the scope of protection of the present innovation.

The electromagnetic fuel injector 1 described above has numerous advantages.

Firstly, the electromagnetic fuel injector 1 described above has a low noise level and a modest degradation (wear) thanks to the fact that (at the end of the opening step) the impact of the armature 19 against the main armature 14 and (at the end of the closing step) the impact of the shutter 9 against the valve seat of the injection valve 7 occur at relatively reduced impact speeds. Furthermore, in this manner also the bounce phenomena are reduced which introduce a certain dose of randomness in the quantity of fuel which is injected.

Furthermore, the electromagnetic fuel injector 1 described above results to be simple and cost-effective to produce since it has few constructive differences which are easy to manufacture with respect to a similar known electromagnetic injector.

### LIST OF THE REFERENCE NUMERALS OF THE FIGS.

1 fuel injector
2 longitudinal axis
3 injection nozzle
4 support body
5 supply channel
6 electromagnetic actuator
7 injection valve
8 plunger
9 shutter
10 closing spring
11 main electromagnet
12 secondary electromagnet
13 main coil
14 main armature
15 central hole
16 secondary coil
17 secondary armature
18 central hole
19 armature
20 control unit
21 controller
22 controller

1) An electromagnetic fuel injector (1) comprising:
a tubular support body (4);
an injection nozzle (3) arranged at an end of the support body (4);
an injection valve (7) coupled to the injection nozzle (3);
a plunger (8), which is movable, so as to adjust the fuel flow through the injection nozzle (3), between a closed position and an open position of the injection valve (7);
an electromagnetic actuator (6) provided with a main electromagnet (11) configured, when it is activated, to apply a force to the plunger (8), which pushes the plunger (8) towards the open position of the injection valve (7) and provided with a secondary electromagnet (12) configured, when it is activated, to apply a force to the plunger (8), which pushes the plunger (8) towards the closed position of the injection valve (7);
a closing spring (10) configured to push the plunger (8) towards the closed position of the injection valve (7); and
a control unit (20) configured, so as to open the injection valve (7), to activate the main electromagnet (11) so that the main electromagnet (11) generates a magnetic force moving the plunger (8) towards the open position, overcoming the elastic force of the closing spring (10);
wherein the control unit (20) is configured to activate, during the opening of the injection valve (7) and when the plunger (8) is close to the open position, also the secondary electromagnet (12) so that the secondary electromagnet (12) generates a magnetic force slowing down the movement of the plunger (8) towards the open position.

2) The electromagnetic injector (1) according to claim 1, wherein the electromagnetic actuator (6) comprises one single armature (19), which is movable, is integral with the plunger (8) and is shared by both electromagnets (11, 12), since it is subjected to the magnetic forces generated by both electromagnets (11, 12).

3) The electromagnetic injector (1) according to claim 2, wherein:
the main electromagnet (11) comprises a main armature (14), which is integral with the support body (4), and a main coil (13), which is arranged in the area of the main armature (14);
the secondary electromagnet (12) comprises a secondary armature (17), which is integral with the support body (4), and a secondary coil (16), which is arranged in the area of the secondary armature (17); and
the armature (19) is arranged between the main armature (14) and the secondary armature (17).

4) The electromagnetic injector (1) according to claim 3, wherein:
the closed position of the injection valve (7) is determined by a contact of a shutter (9) of the plunger (8) against a valve seat of the injection valve (7); and
the open position of the injection valve (7) is determined by a contact of the movable armature (19) against the main armature (14).

5) The electromagnetic injector (1) according to claim 3, wherein:
the two coils (13, 16) of the two electromagnets (11, 12) are not connected to each other in series or in parallel; and
the control unit (20) is configured to electrically power the two coils (13, 16) of the two electromagnets (11, 12) independently of each other.

6) The electromagnetic injector (1) according to claim 3, wherein the control unit (20) is configured, so as to open the injection valve (7), to:
activate the main electromagnet (11) so that the main electromagnet (11) generates a magnetic force attracting the armature (19) towards the main armature (14), overcoming the elastic force of the closing spring (10), thus moving the armature (19) towards the open position; and
also activate, when the armature (19) is close to the open position, the secondary electromagnet (12), so that the secondary electromagnet (12) generates a magnetic force attracting the armature (19) towards the secondary armature (17), consequently slowing down the movement of the armature (19) towards the open position.

7) The electromagnetic injector (1) according to claim 6, wherein the control unit (20) is configured to deactivate the secondary electromagnet (12) before the armature (19) reaches the open position.

8) The electromagnetic injector (1) according to claim 6, wherein the control unit (20) is configured, so as to close the injection valve (7), to:
turn the main electromagnet (11) off, so that the armature (19) is pushed towards the closed position by the elastic force generated by the closing spring (10); and
activate, when the armature (19) is close to the closed position, the main electromagnet (11), so that the main electromagnet (11) generates a magnetic force attracting the armature (19) towards the main armature (14), consequently slowing down the movement of the armature (19) towards the closed position.

9) The electromagnetic injector (1) according to claim 8, wherein the control unit (20) is configured to deactivate the main electromagnet (11) before the armature (19) reaches the closed position.

10) The electromagnetic injector (1) according to claim 1, wherein the control unit (20) is configured to deactivate the secondary electromagnet (12) before the plunger (8) reaches the open position.

11) The electromagnetic injector (1) according to claim 1, wherein the control unit (20) is configured, so as to close the injection valve (7), to
turn the main electromagnet (11) off, so that the plunger (8) is pushed towards the closed position by the elastic force generated by the closing spring (10); and
activate, when the plunger (8) is close to the closed position, the main electromagnet (11), so that the main electromagnet (11) slows down the movement of the plunger (8) towards the closed position.

12) The electromagnetic injector (1) according to claim 11, wherein the control unit (20) is configured to deactivate the main electromagnet (11) before the plunger (8) reaches the closed position.

13) A control method to control an electromagnetic fuel injector (1) comprising:
a tubular support body (4);
an injection nozzle (3) arranged at an end of the support body (4);
an injection valve (7) coupled to the injection nozzle (3);
a plunger (8), which is movable, so as to adjust the fuel flow through the injection nozzle (3), between a closed position and an open position of the injection valve (7);
an electromagnetic actuator (6) provided with a main electromagnet (11) configured, when it is activated, to apply a force to the plunger (8), which pushes the plunger (8) towards the open position of the injection valve (7) and provided with a secondary electromagnet (12) configured, when it is activated, to apply a force to the plunger (8), which pushes the plunger (8) towards the closed position of the injection valve (7); and
a closing spring (10) configured to push the plunger (8) towards the closed position of the injection valve (7);
the control method, so as to open the injection valve (7), comprises the steps of:
activating the main electromagnet (11) so that the main electromagnet (11) generates a magnetic force moving the plunger (8) towards the open position, overcoming the elastic force of the closing spring (10); and
activating, during the opening of the injection valve (7) and when the plunger (8) is close to the open position, also the secondary electromagnet (12), so that the secondary electromagnet (12) generates a magnetic force slowing down the movement of the plunger (8) towards the open position.

14) The control method according to claim 13 and comprising the steps of:
turning the main electromagnet (11) off, so that the plunger (8) is pushed towards the closed position by the elastic force generated by the spring (10); and
activating, when the armature (19) is close to the closed position, the main electromagnet (11), so that the main electromagnet (11) slows down the movement of the plunger (8) towards the closed position.
